(19) United States
(12) Patent Application Publication
(10) Pub. No.: US 2009/0029101 A1
(43) Pub. Date: Jan. 29, 2009

(54) FIBROUS STRUCTURES COMPRISING DISCRETE BOND REGIONS AND METHODS FOR MAKING SAME

(76) Inventors: David Mark Rasch, Cincinnati, OH (US); Ty Gerald Noe, Liberty Township, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/144,020

(22) Filed: Jun. 23, 2008

Related U.S. Application Data
(60) Provisional application No. 60/962,069, filed on Jul. 26, 2007.

(51) Int. Cl. B29C 65/48

(52) U.S. Cl. 428/103; 156/295

(57) ABSTRACT

Fibrous structures having discrete bond regions are provided. More particularly, convolutedly wound rolls of single- or multi-ply fibrous structure having a surface that is affixed to a different surface by a plurality of discrete bond regions, and a method for making same are provided.

### CROSS REFERENCE TO RELATED APPLICATION

This application claims the benefit of U.S. Provisional Application No. 60/962,069, filed Jul. 26, 2007.

### FIELD OF THE INVENTION

The present invention relates to a fibrous structure comprising discrete bond regions. More particularly, to a convolutedly wound roll of a single- or multi-ply fibrous structure comprising a surface that is affixed to a different surface by a plurality of discrete bond regions, and a method for making same.

### BACKGROUND OF THE INVENTION

Fibrous structures comprising bond regions are known in the art. For example, convolutedly wound rolls of single- or multi-ply fibrous structures have utilized adhesives to seal the tails of such rolls of fibrous structure. Such adhesives typically consist of a stripe of adhesive that stretches entirely or substantially entirely across the cross machine direction of the fibrous structure.

In addition, some convolutedly wound rolls of single- or multi-ply fibrous structures have utilized a “stitched” stripe for the tail seal. In effect, the stripe comprises intermittent segments of adhesive of 1.27 cm cross machine direction length extending across the cross machine direction of the fibrous structure.

In addition to the tail seal bond regions, some multi-ply fibrous structures comprise discrete bond regions as the point of embossments that bond two or more plies of the multi-ply fibrous structure together.

The problem of current bond regions, especially bond regions comprising adhesives used for tail sealing and/or transfer gluing, is that the bond regions do not set and/or dry sufficiently prior to being processed by post processing equipment, especially if the bond regions comprise a water-based adhesive.

Accordingly, there is a need for a fibrous structure, especially a convolutedly wound roll of a single- or multi-ply fibrous structure, that comprises bond regions that overcome the problems associated with fibrous structures comprising current bond regions, and a method for making same.

### SUMMARY OF THE INVENTION

The present invention solves the problem associated with fibrous structures comprising current bond regions by providing a fibrous structure, especially a convolutedly wound roll of a single- or multi-ply fibrous structure comprising a surface that is affixed to a different surface by a plurality of discrete bond regions, and a method for making same.

In one example of the present invention, a convolutedly wound roll of a single- or multi-ply fibrous structure comprising a surface that is affixed to a different surface by a plurality of discrete bond regions wherein one or more of the discrete bond regions exhibits a bond region length of less than 1.27 and/or less than 1 and/or less than 0.75 and/or less than 0.50 and/or less than 0.25 and/or less than 0.10 and/or less than 0.05 cm to about 0 cm is provided.

In another example of the present invention, a method for making a roll of single- or multi-ply fibrous structure, the method comprising the step of affixing a surface of the single- or multi-ply fibrous structure to a different surface by a plurality of discrete bond regions having a bond region length of less than 1.27 and/or less than 1 and/or less than 0.75 and/or less than 0.50 and/or less than 0.25 and/or less than 0.10 and/or less than 0.05 cm to about 0 cm is provided.

In yet another example of the present invention, a single or multi-ply sanitary tissue product comprising a convolutedly wound roll of a single- or multi-ply fibrous structure according to the present invention is provided.

Accordingly, the present invention provides a fibrous structure, especially a convolutedly wound roll of a single- or multi-ply fibrous structure comprising a surface that is affixed to a different surface by a plurality of discrete bond regions, and a method for making same.

### BRIEF DESCRIPTION OF THE DRAWINGS

FIG. 1 is a perspective representation of one example of a convolutedly wound roll of fibrous structure according to the present invention;

FIG. 2 is a perspective representation of another example of a convolutedly wound roll of fibrous structure according to the present invention;

FIG. 3 is a perspective representation of another example of a convolutedly wound roll of fibrous structure according to the present invention;

FIG. 4 is a front view of another example of a convolutedly wound roll of fibrous structure according to the present invention; and

FIG. 5 is a perspective representation of an example of a modified plate useful in making an example of a convolutedly wound roll of fibrous structure according to the present invention.

### DETAILED DESCRIPTION OF THE INVENTION

“Fiber” as used herein means an elongate particulate having an apparent length greatly exceeding its apparent width, i.e. a length to diameter ratio of at least about 10. Fibers have some integrity, i.e. manifested by some intrinsic strength. If an apparent elongate particulate, supported by a substrate, fails to have enough instrinsic strength to support itself, it is not a fiber, but may be a faux fiber. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, and bagasse can be used in this invention. Synthetic fibers and/or non-naturally occurring fibers, such as polymeric fibers including natural polymeric fibers such as starch and/or modified starch polymeric fibers, can also be used. Elastomeric polymers, polypropylene, polyethylene, polyester, polyolefin, and nylon, can be used. The polymeric fibers can be produced by spunbond processes, meltblown processes, and other suitable methods known in the art.

An embryonic fibrous web can be typically prepared from an aqueous dispersion of papermaking fibers, though dispersions in liquids other than water can be used. The fibers are dispersed in the carrier liquid to have a consistency of from about 0.1 to about 0.3 percent. It is believed that the present invention can also be applicable to moist forming operations where the fibers are dispersed in a carrier liquid to have a consistency of less than about 50% and/or less than about 10%. Further, it is believed that the present invention can also be applicable to dry forming operations wherein the fibers are dispersed in air.

“Fibrous structure” as used herein means a structure that comprises one or more fibers. In one example, a fibrous structure according to the present invention means an orderly arrangement of fibers within a structure in order to perform a function. Nonlimiting examples of fibrous structures of the present invention include composite materials (including reinforced plastics and reinforced cement), paper, fabrics (including woven, knitted, and non-woven), and absorbent pads (for example for diapers or feminine hygiene products). A bag of loose fibers is not a fibrous structure in accordance with the present invention.

Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structure may be convolutedly wound upon itself about a core or without a core to form a convolutedly wound roll of fibrous structure.

The fibrous structures of the present invention may be homogeneous or may be layered. If layered, the fibrous structures may comprise at least two and/or at least three and/or at least four and/or at least five layers.

“Sanitary tissue product” as used herein means a soft, low density (i.e. < about 0.15 g/cm3) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a convolutedly wound roll of sanitary tissue product.

In one example, the sanitary tissue product of the present invention comprises a fibrous structure according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit a total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The sanitary tissue products of the present invention may exhibit a density of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue product rolls of the present invention may comprise a plurality of connected, but perforated sheets, that are separably dispensable from adjacent sheets.

The sanitary tissue products of the present invention may comprises additives such as softening agents, temporary wet strength agents, permanent wet strength agents, bulk softening agents, lotions, silicones, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²).

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Bond region length” as used herein means the distance the bond region extends along its major axis. If a bond region is a perimeter of a shape, such as a perimeter of a circle, square, diamond or some other shape, then the length is determined by picking a point on the perimeter and measuring around the perimeter to the point again. The bond regions may be of different lengths and/or shapes and/or thicknesses. In one example, the bond region comprises a minimum thickness (the distance across the bond region along the bond regions minor axis is less than about 4 mm and/or less than about 3 mm and/or less than about 2 mm and/or less than about 1.5 mm and/or less than about 1 mm and/or less than about 0.5 mm to about 0 mm.

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

As used herein, the articles “a” and “an” when used herein, for example, “an emulsifying agent” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Single- or Multi-Ply Fibrous Structure

The fibrous structure of the present invention may be in the form of a convolutedly wound roll of a single- or multi-ply fibrous structure.

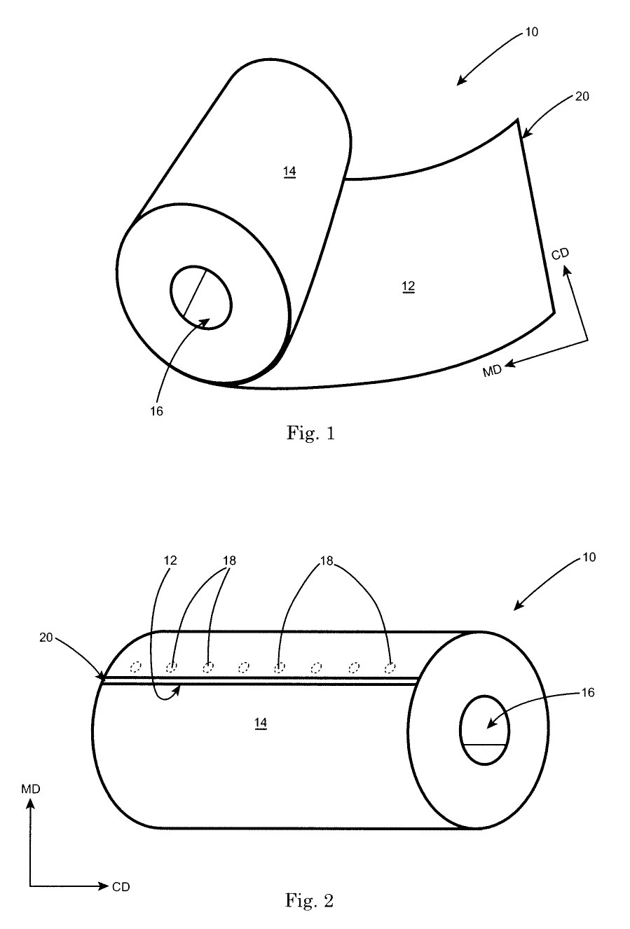

As shown in FIG. 1, the convolutedly wound roll of single-ply fibrous structure 10 may comprise a surface 12 and a different surface 14. The convolutedly wound roll of fibrous structure 10 is wound about a core 16. Even though FIG. 1 and FIGS. 2 and 3, both described below, illustrate a single-ply fibrous structure 10, the figures and the description related thereto also applies to a multi-ply fibrous structure.

As shown in FIG. 2, the surface 12 may be affixed to the different surface 14 by a plurality of discrete bond regions 18. The discrete bond regions 18 exhibit a bond region length of less than 1.27 cm. In one example, the major axis of the bond region extends, at least partially in the cross machine direction. The cross machine direction is represented by the reference “CD” in the figures. The machine direction is represented by the reference “MD” in the figures. As shown in FIGS. 1 and 2, the convolutedly wound roll of single-ply fibrous structure 10 comprises a surface 12, which is a bottom surface, and a different surface 14, which is a top surface. The convolutedly wound roll of single-ply fibrous structure 10 also comprises a tail end 20. In one example, one or more discrete bond regions are positioned at a machine direction distance of less than about 25 cm and/or less than about 20 cm and/or less than about 15 cm and/or less than about 10 cm and/or less than about 7 cm and/or less than about 5 cm and/or to about 0.5 cm and/or to about 1 cm from the tail end 20 of the single ply fibrous structure 10.

In another example, a convolutedly wound roll of a single- or multi-ply fibrous structure comprising a plurality of unitary implements that can be separated from an adjacent implement during use comprises a two or more groups of discrete bond regions, such that once the first implement comprising the tail end of the roll is separated (dispensed) from the roll, a new tail end of the roll is formed by the adjacent implement from which the first implement is separated. The adjacent implement may be affixed to a surface of the roll by a plurality of discrete bond regions. This arrangement of groups of discrete bond regions may be repeated throughout the roll of single- or multi-ply fibrous structure to achieve the same function and result.

As shown in FIG. 3, a partial section of a convolutedly wound roll of single-ply fibrous structure 10 comprises a surface 12, which is a bottom surface, that is affixed to a different surface 14, for example an exterior surface of a core 16, by a plurality of discrete bond regions 18.

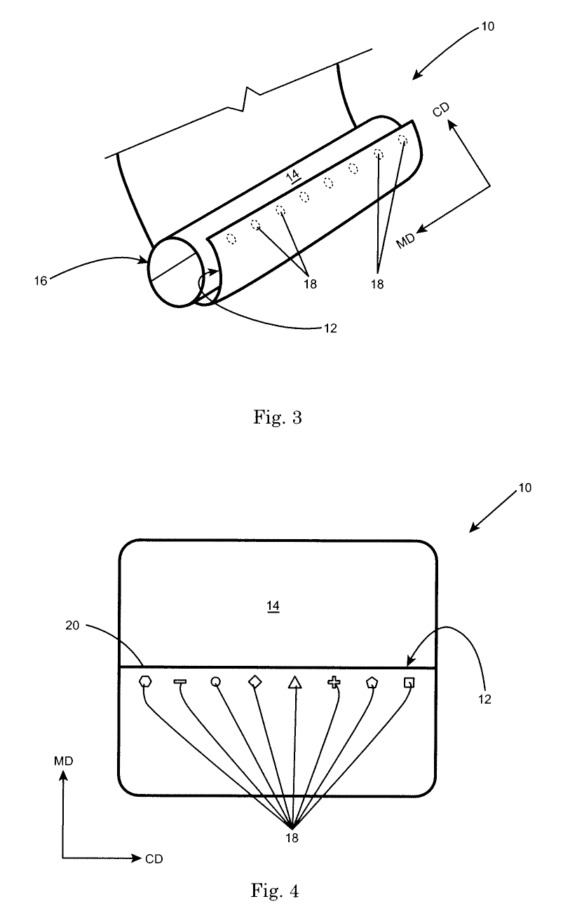

One or more of the discrete bond regions 18 may exhibit a shape selected from the group consisting of: circles, stars, arcs, hearts, crosses, polygons and mixtures thereof. The polygons may be selected from the group consisting of: squares, rectangles, triangles, diamonds, trapezoids, pentagons, hexagons, heptagons, octagons and mixtures thereof. In one example, the shapes may be defined by a perimeter only and/or may be solid such as dots, dashes, and the like. Nonlimiting examples of bond regions are shown in FIG. 4 in the convolutedly wound roll of single-ply fibrous structure 10.

Three or more of the discrete bond regions may be arranged in a line along the cross machine direction of the convolutedly wound roll of single- or multi-ply fibrous structure.

In one example, the discrete bond regions may be arranged in a non-random repeating pattern along the cross machine direction of the convolutedly wound roll of single- or multi-ply fibrous structure.

### Adhesive

One or more of the discrete bond regions may comprise an adhesive. The adhesive may be a water-based adhesive. Nonlimiting examples of suitable adhesives are known in the art. For example, a water-based adhesive may comprises an adhesive obtained from polymerizing ethylene and propylene monomeric units.

Examples of suitable adhesives are commercially available from H.B. Fuller under the trade names WB-4955M, WB-4989 and WB-4997, Henkel under the brand name Adhesin® and National Starch & Chemical Company.

### Method

A convolutedly wound roll of single- or multi-ply fibrous structure according to the present invention may be made by any suitable method known in the art so long as a plurality of discrete bond regions are formed. In one example, the convolutedly wound roll of single- or multi-ply fibrous is made by a method comprising the step of affixing a surface of the convolutedly wound roll of single or multi-ply fibrous structure to a different surface by a plurality of discrete bond regions having a bond region length of less than 1.27 cm.

The surface may comprise a bottom surface of the convolutedly wound roll of single- or multi-ply fibrous structure and the different surface may comprise a top surface of the convolutedly wound roll of single- or multi-ply fibrous structure.

In one example, one or more discrete bond regions are positioned at a machine direction distance of less than about 10 cm and/or less than about 7.5 cm and/or less than about 5 cm and/or to about 0 and/or to about 0.5 cm and/or to about 1.2 cm from the tail end 20 of the single ply fibrous structure 10. In one example, one or more discrete bond regions are positioned at a machine direction distance of from about 0 cm to about 7.5 cm and/or from about 0.5 cm to about 5 cm and/or from about 1.2 cm to about 2.5 cm.

In another example, the surface comprises a bottom surface of the convolutedly wound roll of single- or multi-ply fibrous structure and the different surface comprises a core surface about which the convolutedly wound roll of single- or multi-ply fibrous structure is convolutedly wound.

The step of affixing may comprise a step of applying an adhesive to one or both of the surface of the convolutedly wound roll of single- or multi-ply fibrous structure and the different surface. The step of applying an adhesive may comprise an application operation selected from the group consisting of: non-contact application, contact application and mixtures thereof.

The non-contact application may comprise spraying the adhesive onto one or more surfaces of the convolutedly wound roll of single- or multi-ply fibrous structure or onto a different surface such as an exterior surface of a core about which the single- or multi-ply fibrous structure may be convolutedly wound. The spray application may utilize an aerosol spray application and/or a non-aerosol spray application.

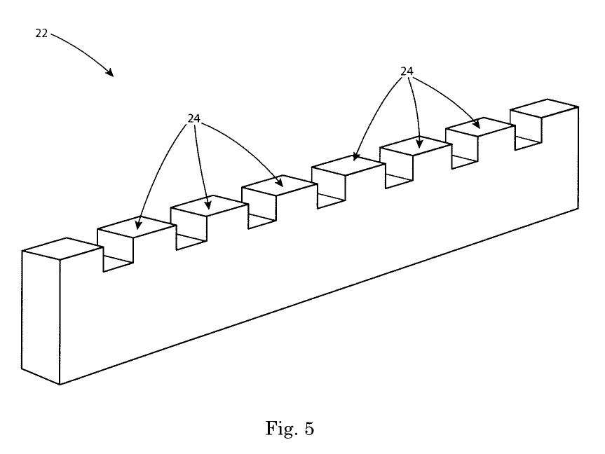

The contact application may comprise an operation selected from the group consisting of: extruding, printing, surface transfer and mixtures thereof. In one example, the surface transfer comprises contacting surface 12 and/or different surface 14 (a surface of the convolutedly wound roll of single- or multi-ply fibrous structure and/or the exterior surface of the core) with a plate from a tail sealer, for example a tail sealer commercially available from Fabio Perini S.p.A. For example, the convolutedly wound roll of single-ply fibrous structure 10 of FIG. 1 may be processed by a tail sealer from Fabio Perini S.p.A., such that a modified plate 22 of FIG. 5, which has been modified to deliver an adhesive to different surface 14 via a plurality of discrete elements 24, such that when surface 12 of the convolutedly wound roll of single-ply fibrous structure 10 contacts the adhesive present on the different surface 14 a plurality of discrete bond regions 18 are formed thus bonding surface 12 to the different surface 14.

The plurality of discrete elements 24 of the modified plate 22 may individually be any size and/or shape so long as the plurality of bond regions 18 produced by the adhesive delivered by the plurality of discrete elements comprises at least one bond region that exhibits a bond region length of less than 1.27 cm.

In another example, in a transfer glue operation where a surface of a convolutedly wound roll of single- or multi-ply fibrous structure is affixed to a core, the modified plate 22 of FIG. 5 may be used to deliver adhesive to the exterior surface of the core prior to the surface of the convolutedly wound roll of single- or multi-ply fibrous structure contacts the adhesive. Alternatively, especially in the case of a center winder, the adhesive may be delivered to the exterior surface of the core via an extruder as the core is being moved into position within the center winder.

The plurality of bond regions may be formed in an individual convolutedly wound roll of single- or multi-ply fibrous structure and/or in a log, such as a 100 inch wide convolutedly wound roll of single- or multi-ply fibrous structure, prior to being log sawed into individual convolutedly wound roll of single- or multi-ply fibrous structure.

In one example, the adhesive utilized in the present invention comprises a water-based adhesive. The water-based adhesive may comprise less than 99% and/or less than about 98% and/or less than about 97% and/or less than about 95% and/or less than about 93% and/or less than about 90% by weight of water and/or greater than about 40% and/or greater than about 50% and/or greater than about 60% and/or greater than about 70% and/or greater than about 80% by weight of water.

In one example, especially for tail seal operations, the water-based adhesive comprises from about 99% to about 80% and/or from about 97% to about 85% and/or from about 96% to about 89% by weight of water.

In another example, especially for transfer glue operations, the water-based adhesive comprises from about 80% to about 30% and/or from about 75% to about 40% and/or from about 73% to about 42% by weight of water.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A convolutedly wound roll of single- or multi-ply fibrous structure comprising a surface that is affixed to a different surface by a plurality of discrete bond regions where one or more of the discrete bond regions exhibits a bond region length of less than 1.27 cm.

2. The roll of fibrous structure according to claim 1 wherein the surface comprises a bottom surface of the convolutedly wound roll of single- or multi-ply fibrous structure and the different surface comprises a top surface of the fibrous structure.

3. The roll of fibrous structure according to claim 2 wherein the bottom surface is more proximate to a tail end of the convolutedly wound roll of single- or multi-ply fibrous structure than the top surface.

4. The roll of fibrous structure according to claim 1 wherein the surface comprises a bottom surface of the convolutedly wound roll of single- or multi-ply fibrous structure and the different surface comprises a core surface about which the convolutedly wound roll of single- or multi-ply fibrous structure is convolutedly wound.

5. The roll of fibrous structure according to claim 1 wherein one or more of the discrete bond regions comprise an adhesive.

6. The roll of fibrous structure according to claim 5 wherein the adhesive comprises a water-based adhesive.

7. The roll of fibrous structure according to claim 1 wherein one or more of the discrete bond regions exhibit a shape selected from the group consisting of: circles, stars, arcs, hearts, crosses, polygons and mixtures thereof.

8. The roll of fibrous structure according to claim 7 wherein the polygons are selected from the group consisting of: squares, rectangles, triangles, trapezoids, diamonds, pentagons, hexagons, heptagons, octagons and mixtures thereof.

9. The roll of fibrous structure according to claim 1 wherein three or more of the discrete bond regions are arranged in a line.

10. The roll of fibrous structure according to claim 1 wherein the discrete bond regions are arranged in a non-random repeating pattern along the cross machine direction of the convolutedly wound roll of single- or multi-ply fibrous structure.

11. The roll of fibrous structure according to claim 1 wherein at least one of the bond regions is positioned at a distance of less than about 10 cm from a tail end of the convolutedly wound roll of single- or multi-ply fibrous structure.

12. The roll of fibrous structure according to claim 1 wherein at least one of the bond regions is positioned at a distance of less than about 7.5 cm from a tail end of the convolutedly wound roll of single- or multi-ply fibrous structure.

13. A method for making a roll of convolutedly wound roll of single- or multi-ply fibrous structure, the method comprising the step of affixing a surface of the convolutedly wound roll of single- or multi-ply fibrous structure to a different surface by a plurality of discrete bond regions, wherein one or more of the discrete bond regions exhibits a bond region length of less than 1.27 cm.

14. The method according to claim 13 wherein the surface comprises a bottom surface of the convolutedly wound roll of single- or multi-ply fibrous structure and the different surface comprises a top surface of the convolutedly wound roll of single- or multi-ply fibrous structure.

15. The method according to claim 14 wherein the surface comprises a bottom surface of the convolutedly wound roll of single- or multi-ply fibrous structure and the different surface comprises a core surface about which the convolutedly wound roll of single- or multi-ply fibrous structure is convolutedly wound.

16. The method according to claim 13 wherein the step of affixing comprises a step of applying an adhesive to one or both of the surface of the convolutedly wound roll of single- or multi-ply fibrous structure and the different surface.

17. The method according to claim 16 wherein the step of applying an adhesive comprises an application operation selected from the group consisting of: non-contact applications, contact applications and mixtures thereof.

18. The method according to claim 17 wherein the non-contact application comprises spraying the adhesive.

19. The method according to claim 18 wherein the spraying occurs by an aerosol spray application.

20. The method according to claim 18 wherein the spraying occurs by a non-aerosol spray application.

21. The method according to claim 17 wherein the contact application is selected from the group consisting of: extruding, printing, surface transfer and mixtures thereof.

22. The method according to claim 17 wherein the adhesive comprises a water-based adhesive.

23. The method according to claim 20 wherein the water-based adhesive comprises less than 99% by weight of water.
